(19) United States
(12) Patent Application Publication
(10) Pub. No.: US 2025/0328029 A1
(43) Pub. Date: Oct. 23, 2025

(54) ELECTROMAGNETICALLY ACTUATED OPHTHALMIC LENS DEVICE AND SYSTEM AND METHODS OF USE THEREOF

(71) Applicant: VANDERBILT UNIVERSITY, Nashville, TN (US)

(72) Inventors: Peter Podar, Nashville, TN (US); Supriyo Rana, Nashville, TN (US); Amaya King, Nashville, TN (US); Megan McKeen, Nashville, TN (US)

(21) Appl. No.: 19/185,600

(22) Filed: Apr. 22, 2025

Related U.S. Application Data
(60) Provisional application No. 63/637,067, filed on Apr. 22, 2024.

(51) Int. Cl. G02C 7/02; G02C 7/06

(52) U.S. Cl. CPC G02C 7/022; G02C 7/06

(57) ABSTRACT

The present disclosure provides for devices, systems, and methods of using electromagnetically actuated ophthalmic lens. The lens includes a first chamber and a second chamber, the second chamber being connected to the first chamber to form a central void. The lens further includes a membrane layer disposed between the first chamber and the second chamber in the central void, the membrane layer being flexible and with an inner ridge. Additionally, the lens includes an electromagnet disposed between the first chamber and the membrane layer, the electromagnet adjacent to the inner ridge of the membrane layer and a magnet disposed between the second chamber and the membrane layer, the magnet adjacent to the inner ridge of the membrane layer.

### CROSS-REFERENCE TO RELATED APPLICATIONS

This application claims benefit of U.S. Provisional Application No. 63/637,067, filed on Apr. 22, 2024, which is hereby incorporated by reference in its entirety.

### BACKGROUND

Refractive errors such as presbyopia (age-related refractive error), hyperopia (farsightedness), and myopia (nearsightedness) affect billions of people worldwide and represent a leading cause of visual impairment. Globally, an estimated 2 billion individuals are affected by presbyopia, with approximately 1.3 billion experiencing hyperopia and over 2.6 billion affected by myopia. Current intervention options primarily involve static corrective lenses-either single-vision glasses for specific distances or multifocal lenses designed to provide accommodation with a range of focal powers. However, existing multifocal and progressive lens solutions introduce visual distortions, limit the effective field of view, compromise peripheral clarity, and require the user to adapt to segmented or gradient focal zones, reducing overall visual comfort, acuity, and natural visual experience.

### SUMMARY

In accordance with the purpose(s) of this disclosure, as embodied and broadly described herein, the disclosure, in various aspects, relates to electromagnetically actuated ophthalmic lens. According to various aspects of the present disclosure, there is provided a lens, comprising: a first chamber; a second chamber connected to the first chamber to form a central void; a membrane layer disposed between the first chamber and the second chamber in the central void, the membrane layer being flexible with an inner ridge; an electromagnet disposed between the first chamber and the membrane layer, the electromagnet adjacent to the inner ridge of the membrane layer; and a magnet disposed between the second chamber and the membrane layer, the magnet adjacent to the inner ridge of the membrane layer.

The present disclosure also provides for methods, comprising: adjusting a focal power of a lens, wherein the lens comprises: a first chamber; a second chamber connected to the first chamber to form a central void; a membrane layer disposed between the first chamber and the second chamber in the central void, the membrane layer being flexible with an inner ridge; an electromagnet disposed between the first chamber and the membrane layer, the electromagnet adjacent to the inner ridge of the membrane layer; and a magnet disposed between the second chamber and the membrane layer, the magnet adjacent to the inner ridge of the membrane layer; and wherein the focal power of the lens is adjusted by applying electromagnetic actuation to adjust a curvature of the membrane layer of the lens.

In various aspects of the present disclosure, a system is provided comprising: an eyeglass frame; and two lenses, wherein each lens comprises: a first chamber; a second chamber connected to the first chamber to form a central void; a membrane layer disposed between the first chamber and the second chamber in the central void, the membrane layer being flexible with an inner ridge; an electromagnet disposed between the first chamber and the membrane layer, the electromagnet adjacent to the inner ridge of the membrane layer; and a magnet disposed between the second chamber and the membrane layer, the magnet adjacent to the inner ridge of the membrane layer.

Other systems, methods, devices, features, and advantages of the devices and methods will be or become apparent to one with skill in the art upon examination of the following drawings and detailed description. It is intended that all such additional systems, methods, devices, features, and advantages be included within this description, be within the scope of the present disclosure, and be protected by the accompanying claims.

### BRIEF DESCRIPTION OF THE DRAWINGS

Further aspects of the present disclosure will be more readily appreciated upon review of the detailed description of its various embodiments, described below, when taken in conjunction with the accompanying drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is an exploded view of one example of an electromagnetically actuated ophthalmic lens according to various embodiments of the present disclosure.

FIGS. 2A and 2B are illustrations of an example of a membrane layer of the lens according to various embodiments of the present disclosure. FIG. 2A represents an example of a membrane layer of a converging lens and FIG. 2B represents an example of a membrane layer of a diverging lens.

FIGS. 3A and 3B show the fluid flow of the lens according to various embodiments of the present disclosure. FIG. 3A illustrates fluid flow of the lens to form a converging lens by increasing pressure in the central void to form a bulging membrane layer. FIG. 3B illustrates the fluid flow of the lens to form a diverging lens by decreasing pressure in the central void to form a concave membrane layer.

FIG. 4 is an example of a prototype of eyeglasses employing the electromagnetically actuated ophthalmic lens developed for testing according to various embodiments of the present disclosure.

FIG. 5 is a flowchart depicting an example of a fabrication process for the electromagnetically actuated ophthalmic lens according to various embodiments of the present disclosure.

### DETAILED DESCRIPTION

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, ophthalmic engineering techniques, electromagnetic actuation techniques and the like, which are within the skill of the art. Such techniques are explained fully in the literature.

The following examples are put forth to provide those of ordinary skill in the art with a complete disclosure and description of how to perform the methods and use the compositions and compounds disclosed and claimed herein. Efforts have been made to ensure accuracy with respect to numbers (e.g., amounts, measurements, etc.), but some errors and deviations should be accounted for.

Before the embodiments of the present disclosure are described in detail, it is to be understood that, unless otherwise indicated, the present disclosure is not limited to particular materials, machines, computing processes, or the like, as such can vary. It is also to be understood that the terminology used herein is for purposes of describing particular embodiments only and is not intended to be limiting. It is also possible in the present disclosure that steps can be executed in different sequence where this is logically possible.

It should be noted that ratios, amounts, and other numerical data can be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to about 5%” should be interpreted to include not only the explicitly recited values of about 0.1% to about 5%, but also include individual values (e.g., 1%, 2%, 3%, and 4%) and the sub-ranges (e.g., 0.5%, 1.1%, 2.2%, 3.3%, and 4.4%) within the indicated range. Where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In some embodiments, the term “about” can include traditional rounding according to significant figures of the numerical value. In addition, the phrase “about ‘x’ to ‘y’”, where ‘x’ and ‘y’ are numerical values, includes “about ‘x’ to about ‘y’”.

### Discussion

Disclosed are various approaches for electromagnetically actuated ophthalmic lens, systems including electromagnetically actuated ophthalmic lens, and methods of using electromagnetically actuated ophthalmic lens, and the like.

Accordingly, various embodiments of the present disclosure are directed to systems and methods for an electromagnetically actuated ophthalmic lens with adjustable focal power. Current corrective lenses targeted for presbyopia and other focus-related eyesight disorders are static and incapable of adapting to changes in vision and the intended viewing target of wearers, often compromising clarity in peripheral regions of the field-of-view. Unfortunately, this can present other challenges with those suffering from focus-related eyesight disorders such as impaired depth perception and equilibrium, dizziness, and fatigue. The present disclosure, however, can allow for a tunable focus that can be precisely adjusted to match the prescripts of the wearer and can provide enhanced vision over a broad range of distances, and can automatically adjust based at least in part on the user's intended viewing target distance. In other words, the present disclosure can allow for a single lens to precisely match foci that would have previously required a series of discrete, field-of-view limiting static lenses. Additionally, unlike the static lenses, the present disclosure can allow for a clear, non-distorted field of view over a wide range of distances. Further, in various examples, the present disclosure can achieve seamless, automatic focus modulation based at least in part on the wearer's desired depth of view. In various examples, the lens can be used for other visual applications for refractive error diagnosis in a breadth of settings, including low-resource areas. Additionally, the lens can be used in other non-ophthalmologic applications and devices that require modulation of focal power

In various embodiments, the present disclosure can include an eyeglass-compatible liquid lens that can change shape and focal depth on demand. According to various examples of the present disclosure, a wearer can adjust the lens to rapidly match most focal corrections (e.g. −6D to +10D) by modulating a voltage provided by the battery. The present disclosure can adjust the lens' natural, zero-voltage shape or focus in a matter of seconds to account for an individual's baseline prescription. Further in some embodiments of the present disclosure, by tracking eye vergence, the lens can automatically change focus based at least in part on the distance of the wearer's viewing target using infrared-tracking of pupils through coordinated localization and vergence estimation.

According to various embodiments of the present disclosure, a lens and a method of using the lens can include a first chamber and a second chamber. The two chambers can be connected to form a central void. A membrane layer can be disposed between the first chamber and the second chamber in the inner void. Also, the membrane layer can have an inner ridge along the perimeter of the membrane layer inset from the edge of the membrane layer. Further, the lens can include an electromagnet disposed between the first chamber and the membrane layer. In various examples, the electromagnet can be adjacent to the inner ridge of the membrane layer. Additionally, the lens can include a magnet disposed between the second chamber and the membrane layer. Similar to the electromagnet, but separated by the membrane layer, the magnet can be placed adjacent to the inner ridge of the membrane layer. The lens can have an adjustable focal power when the focal power of the lens can be adjusted by applying electromagnetic actuation to adjust a curvature of the membrane layer of the lens. In some embodiments, the relative positions of the magnet and electromagnet can be switched. The magnet can be the mobile entity while the electromagnet remains stationary. Additionally, because of their material density but similar profile and volume, their inertia is different due to different mass. The magnet has a greater inertia, and as a result, will resist change in motion more significantly than the electromagnet, thus the resultant focus speed during actuation can be different. Thus, in some examples, the magnet size and the electromagnet size can be adjusted to control focus speed, device thickness, power range requirement, and focal range.

In various examples, the membrane layer can be made of a flexible material that is optically clear. In some examples, the entire membrane layer is made of an optically clear, flexible material and in other examples, only the center portion of the membrane layer is made of an optically clear, flexible material with the outer perimeter in some examples being reinforced for stability. For example, the membrane layer can be made of an optically clear, flexible material such as a polymethylmethacrylate (PMMA), a polydimethylsiloxane (PDMS), an off-stoichiometry thiol-ene polymer, a silicone elastomer, a polyurethane elastomer, a liquid silicone rubber, a fluorinated ethylene propylene, a styrene methyl methacrylate, a polyethylene terephthalate glycol, or a combination thereof. In a particular aspect, the membrane can be made of PMMA.

According to various embodiments of the present disclosure, the lens can include an optical fluid dispersed between the second chamber and the membrane layer. In various examples, the optical fluid can have a high-refractive index. For example, the optical fluid can be a silicone oil.

In an aspect, the lens can also include support elements to aid in the structural stability of the lens, maintain a clear field of view for the wearer, and reduce tangential coma, an optical aberration. In various examples, the lens can include a center ridge support. The center ridge support can be placed between the second chamber and the membrane layer on an inner edge of the inner ridge of the membrane layer. The lens can also include a membrane support that can similarly be placed between the second chamber and the membrane layer. The membrane support, however, can support the outer edge of the membrane layer, being paced adjacent to the inner ridge of the membrane layer. In various examples, the membrane support can allow for rapid and accurate placement of the membrane layer onto the second chamber. According to some aspects of the present disclosure, the second chamber can also include a center support. The center support of the second chamber can increase stability and aid in connecting the first chamber to the second chamber.

In various examples, the center ridge support and the center support of the second chamber can each have a plurality of openings. These openings can allow optical fluid to flow through the elements, aiding in fluid flow and pressure actuation while controlling the focus speed of the lens by precisely selecting the amount and size of the openings. In various examples, the openings can also ensure less material is needed for the lens as the more openings there are, the lower the mass of the lens. The size, shape, position, and number of the openings can vary based on the fluid type, dimensions of the void, dimensions of the membrane, and the like and can influence the structural strength of the ridge while minimizing the material requirements. In an aspect, the number of openings can be about 3 to 400, or about 6 to 200. In an aspect, the openings can have a circular shape, oval shape, polygonal shape, and the like. The opening can have a longest dimension (e.g., diameter) of about 0.5 mm to 19 mm. In an aspect, all of the openings can have the same shape and size, while in other aspects, the shape and size of the opening can vary depending upon the position of the opening. In an aspect, the opening can be equally spaced apart from one another or the openings can be spaced apart so that the distance two or more pairs of openings is different. In some examples, the structural smoothness (e.g., fileted hole opening) can be optimized to increase or decrease focus speed. For example, an optimal filet for the opening can maximize the speed desired for focus while leaving the opening un-fileted may cause fluid turbulence and decrease the effective focus speed due to impaired fluid transfer between the center and peripheral void.

In some examples, the present disclosure in adjusting the focal power of the lens can apply a positive voltage to the electromagnet, thus attracting the magnet causing the inner ridge of the membrane layer to compress as the magnet is attracted by the positive voltage of the electromagnet. As the inner ridge is compressed, the optical fluid can flow from the inner ridge of the membrane layer and into a central void, the optical fluid increasing in volume in the central void and a resulting pressure pushing against the membrane layer creating a converging lens. In other examples of the present disclosure, in adjusting the focal power of the lens, a negative voltage can be applied to the electromagnet. This negative voltage can repel the magnet, extending the inner ridge of the membrane layer. Optical fluid can flow into the growing space of the inner ridge, decreasing the volume in the central void and resulting in a pressure pulling against the membrane layer to create a diverging lens. In various examples of the present disclosure, the electromagnet and the permanent magnet can also be flipped so that a positive voltage would result in a diverging lens and a negative voltage can result in a converging lens.

In other words, various embodiments of the present disclosure can employ an electromagnetic actuation system to adjust the focal power of a lens to accommodate for all visual distances while having a clear, non-distorted field of view at all ranges. For example, electromagnetic actuation can be used to induce attraction or repulsion between an electromagnet (e.g. a coil of wire) and a permanent magnet by varying the polarity and magnitude of an applied voltage. The attraction versus repulsion can change the distance between the electromagnet and the magnet, displacing a constant volume of optical fluid within the lens and altering the curvature of a flexible, membrane layer within the lens. In various examples, when the electromagnet attracts the magnet, the fluid can be forced through a center ridge support ring and to a central void of the lenses. As the volume of optical fluid increases at the central void, the membrane can be forced to bulge outward, creating a converging lens. In this example, a variable power converging lens is created that can be suitable for correcting hyperopia. Alternatively, in various examples, when the electromagnet repels the magnet, the fluid can be forced towards the periphery and into the inner ridge of the lens, causing the center of the membrane layer to cave in. In these examples, the caved membrane layer can create a diverging lens that can be suitable for correcting myopia. The present disclosure, through these various examples, can be a single mechanism that can be used to adjust for both farsighted and nearsighted requirements, eliminating the need to have a difference mechanism depending on the correction prescription. Additionally, the present disclosure in various embodiments can also correct presbyopia, which can be characterized as requiring variable power requirements in the positive correction, negative correction, or even in both positive and negative correction regimes for an individual (e.g., an individual may need accommodation between 0D to +4.5 D, +2.25 to +5.0, −4.0D to −0.25D, or −2.0D to +1.75D). In various examples, the present disclosure can be used for all of these power “polarity” combinations.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principles disclosed by the following illustrative examples.

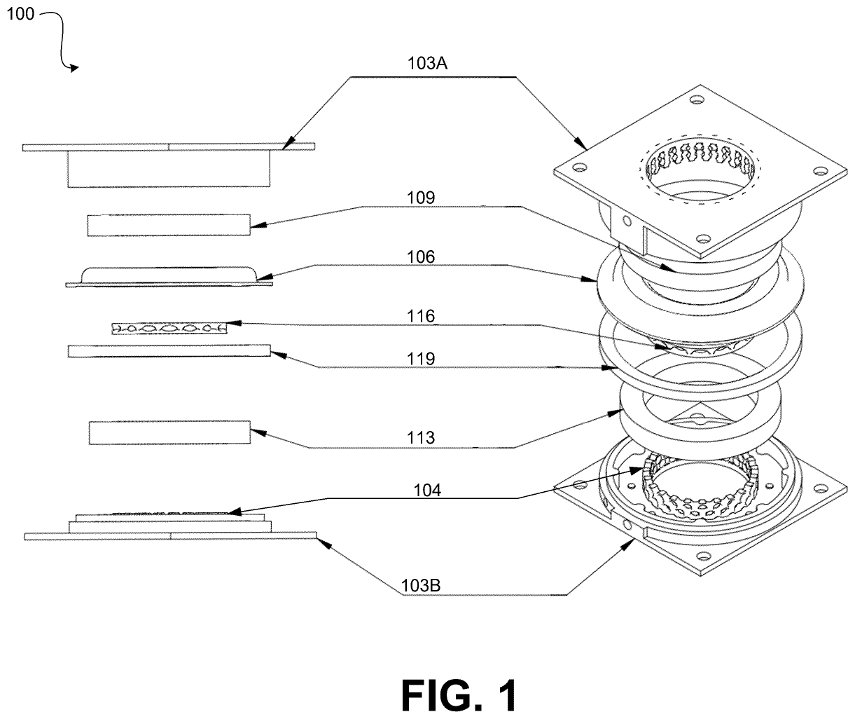

With reference to FIG. 1, shown is an exploded view of a testing module assembly of a lens 100 according to various embodiments of the present disclosure. In some embodiments of the present disclosure, the lens can include chambers 103A and 103B, a membrane layer 106, an electromagnet 109, a magnet 113, a center ridge support 116, a membrane support 119, and an optical fluid 123.

Chambers 103 can represent the outer portions of the lens 100. The chambers 103 can include a first chamber 103A and a second chamber 103B. A first chamber 103A can represent one side of an outer structure of the lens. A second chamber 103B can represent an opposite side of an outer structure of the lens compared to the first chamber 103A. In various examples of the present disclosure, the second chamber 103B can be connected to the first chamber 103A to form an inner void. In the example of FIG. 1, the chambers 103 have a rectangular base as constructed for testing of the lens 100. While a rectangular base is shown, the shape of the chambers 103 can be altered based at least in part on the aesthetic desires of the wearer to be round, oval, square, etc. In an aspect, the chambers 103 can have a total diameter of approximately 44 mm. According to various embodiments of the present disclosure, the diameter of the chambers can range from about 10 mm to 120 mm, or about 35 mm to 60 mm. In some examples, the second chamber 103B can include a center support 104. The center support 104 of the second chamber 103B can increase stability of the lens 100 and can aid in connecting the first chamber 103A to the second chamber 103B. In some aspects, the center support 104 can be a part of the second chamber 103B and in other aspects, the center support 104 can be a removable element snapped in to connect to the second chamber 103B.

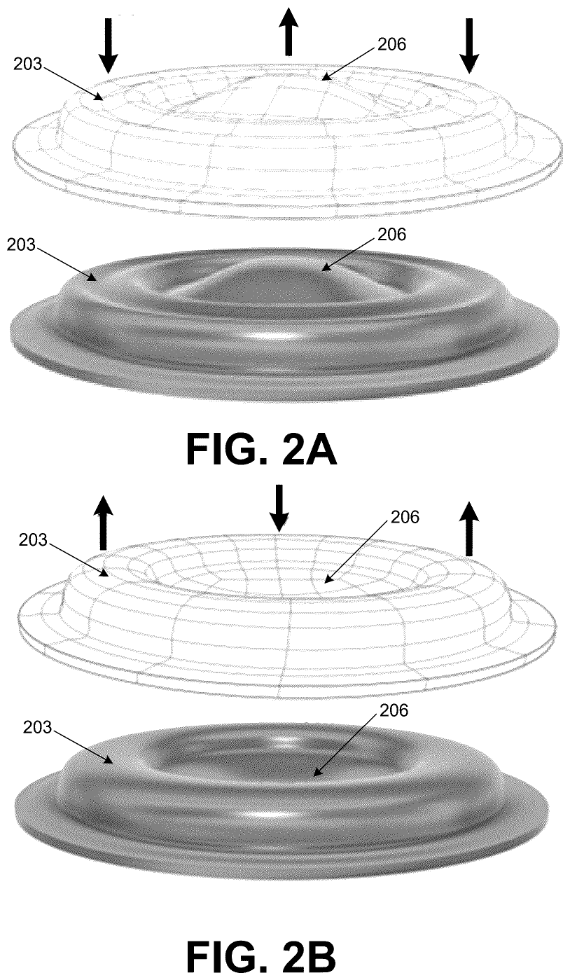

A membrane layer 106 can represent a flexible, transparent membrane disposed between the first chamber 103A and the second chamber 103B in the inner void. For example, the membrane layer 106 can be the controllable, adaptable element of the lens 100 that allows the focal point to be manipulated. In other words, the membrane layer 106 can change shape according to the optical fluid displacement induced by the electromagnetic actuation. In various examples, the membrane layer is flexible and made of an optically clear material (e.g., PMMA, PDMS, an off-stoichiometry thiol-ene polymer, a silicone elastomer, a polyurethane elastomer, a liquid silicone rubber, a fluorinated ethylene propylene, a styrene methyl methacrylate, a polyethylene terephthalate glycol, etc.). The material properties of the membrane layer 106 such as curing ratios, curing times, curing temperatures, elastic properties, thickness, or elastomer formulations can be factors regarding how much force is needed to create a given diopter shift. For example, a thinner, softer membrane layer 106 usually requires less voltage but may be more prone to fatigue whereas a thicker, stiffer membrane layer 106 can tolerate more stress at the expense of higher actuation energy. The shape of the membrane layer 106 is further described in reference to FIGS. 2A and 2B.

An electromagnet 109 can represent a magnetic with a magnetic field induced by an electric current. According to various embodiments of the present disclosure, a voltage can be applied to the electromagnet 109 to induce a magnetic field. The induced magnetic field can determine the direction of the resulting Lorentz force. For example, a negative voltage can induce a magnetic field that repels that magnet 113 and a positive voltage can induce a magnetic field to attract the magnet 113. In some examples, the electromagnet 109 can be a coil of wire, voice-coil actuators, solenoids, appropriate variations of a coil of wire around a ferrite core material to concentrate the resultant magnetic field and strength, etc. The electromagnet 109 can supply electromagnet forces that can be actuated to provide precise, efficient, and variable speed method for changing the curvature of the lens 100 and thereby changing the focus and focal power of the lens 100. The electromagnet's 109 wire gauge, coil diameter, and number of turns can impact the magnetic field strength and power requirements. For example, using a thinner wire increases electrical resistance but allows more windings in a compact space, potentially boosting the force generated at a given current. Alternatively, a lower gauge wire reduces resistance but limits how many turns can fit within the coil.

A magnet 113 can represent an element of the lens 100 with a magnetic field. In some examples of the present disclosure, the magnet 113 can be referred to as a permanent magnet as the magnetic field produced by the magnet is constant. In various examples, the magnet 113 can interact with the electromagnet 109 through attraction and repulsion to shift the focal power of the lens 100. A stronger grade magnet 113 can decrease the required electromagnet current needed to achieve a given focal shift. Additionally, the magnet thickness (e.g., about 3 to 15) and diameter (e.g., about 30 mm to 55 mm) also influence the shape and intensity of the magnetic field, thereby affecting how much the membrane layer 106 deforms. Therefore, if the lens 100 design calls for minimal weight, a thinner or smaller-diameter magnet 113 might be preferred, though this can reduce the maximum available force and field of view per lens 100. In some examples, the magnet 113 can be a ring that can align with or optimize the shape and position relative to the inner ridge 203. In other examples, the magnet 113 can be a plurality of magnets that are positioned along the inner ridge 203. For example, the magnet 113 can represent a number of small disk magnets (e.g., NdFeB Type 42) that can be placed in the lens 100 in a radial position to allow for astigmatism control on a defined angle. For example, eight small disk magnets may be spaced equidistant on the circumference of the inner ridge 203. In this example, two magnets opposite each other may be composed of a stronger magnet composition (e.g., NdFeB type 45) or the two magnets can be oriented with their poles opposite the others' configuration. Therefore, upon application of the voltage, the movement of the two magnets can be different than the other 6, inducing a non-spherical adjustment in the membrane layer 106 curvature that aligns with an individual's astigmatism axis.

According to various examples of the present disclosure, the lens 100 can have an optical viewing area of about 20 mm to 45 mm, or approximately 22 mm. Further in some examples of the present disclosure, the optical aperture of the lens 100 can be adjusted. For example, the magnet 113 can be smaller disk magnets circumscribing an arbitrary large optical aperture. Further, in other examples, the magnet 113 can be a ring magnet with customized dimensions to increase the inner diameter and keep a small ratio between the inner and outer diameter to aid in minimizing extra radial volume. In these examples, the electromagnet 109 can be fabricated to match the necessary aperture.

A center ridge support 116 can represent a support element positioned between the second chamber 103B and the membrane layer 106. In various examples, the center ridge support 116 can support the inner edge of the inner ridge 203 (FIG. 2) of the membrane layer 106. The structural integrity of the center ridge support 116 can minimize sagging and distortion of the membrane layer 106 due to gravity and fluid pressure differential when the lens 100 is oriented perpendicular to the grown. Additionally, the center ridge support 116 thickness (e.g., about 0.1 mm to 15 mm) and an outer diameter (e.g., about 20 mm to 45 mm) can influence the structural support provided by the center ridge support 116. Without the connection between the inner edge of the inner ridge 203 of the membrane layer 106 and the center ridge support 116, the membrane layer 106 can sag from the combine effects of the peripheral masses and induced pressure from the optical fluid 123, membrane layer 106, and the electromagnet 109. By adding support, the center ridge support 116 can enhance structural stability and reduce optical aberrations (e.g. tangential coma). In some examples, the center ridge support 116 can be a ring or any shape, or collection of shapes that traces the inner edge of the inner ridge 203 of the membrane layer 106 and does not obstruct the viewing area through the membrane layer 106. In other examples, the center ridge support can be a plurality of structures place along the inner edge of the inner ridge 203.

Further, in some examples, there can be a plurality of openings throughout the center ridge support 116. In some examples, the center support 104 of the second chamber 103B can also include a plurality of openings. The size and number of openings can be customized to regulate optical fluid flow speed during actuation, allowing for an appropriate accommodation speed based at least in part on the user's inherent age-dependent focus speed. The system can have a controllable focal speed as the focus speed of the eye decreases with age and other conditions that may stiffen the lens or weaken the ciliary muscles. For example, larger openings can result in faster adjustment, appropriate to younger individuals accustomed to a faster focus speed while smaller openings slow the fluid transfer, appropriate for older individuals or other individuals with a slower accommodation time.

A membrane support 119 can represent an element positioned between the second chamber 103A and the membrane layer 106 to add structural integrity to the membrane layer 106. In various examples, the membrane support 119 can be positioned to support the outer edge of the inner ridge 203 (FIG. 2A) of the membrane layer 106. Further, the placement of the membrane support 119 can aid in structural stability, decrease in tangential coma, and decrease the effect of the electromagnet 109 pulling down on the inner ridge 203 of the membrane layer 106. In some examples, the membrane support 119 can be a ring that traces the perimeter of the inner ridge 203 with a thickness of about 2 mm to 6 mm and a diameter of about 35 mm to 60 mm. In other examples, the membrane support 119 can be a plurality of supports placed along the outer perimeter of the inner ridge 203. The membrane support 119 can act as a structural element allowing for a centralized, non-view obstructing support that can aid in ensuring efficient and controllable optical fluid 123 movement.

An optical fluid 123 can represent the fluid dispersed between the second chamber 103B and the membrane layer 116. In various embodiments of the present disclosure, the volume of optical fluid can range from about 1 mL to 10 mL. The displacement of the optical fluid 123 from the peripheral to the center of the lens 100 and vice versa can alter the curvature of the membrane layer 106 to adjust focal power. In various examples, the optical fluid 123 can be a fluid having a high-refractive index (e.g. silicone oil, etc.). For example, the present disclosure allows for refractive index modification based at least in part on different concentrations of optical fluids to fine tune the resting correction power value of the lens 100. In various examples, by selecting a specific optical fluid based at least in part on the refractive index value on a per user basis, the present disclosure can require less volume for the lens 100, decreasing the weight of the lens 100.

Further, in some examples, the lens 100 can include a resting correction setting which can allow for modification of the baseline power correction without an electrical power input. In other words, for power efficiency, the tunable lens 100 can feature the option to preset a resting correction, or the standard correction power that does not require any electrical power input. This can be established by presetting the initial volume of optical fluid 123 in the lens 100 where the initial volume results in the membrane layer 106 taking either a concave or convex shape whichever shape is necessary for visual correction. The baseline power correction can be customized to the user's most common visual distance requirements and can be implemented based at least in part on an initial optical fluid volume adjustment to achieve a slightly convex or concave shape required for the necessary correction power. For example, the initial volume of optical fluid 123, the refractive index of the optical fluid 123, and the thickness of the membrane layer 106 can establish the resting focal power of the lens 100. In some examples, the resting focus can be a flat lens 100. According to various embodiment of the present disclosure, the resting correction volume can be changed whenever a user desires by injecting or removing optical fluid 123 from the lens 100 and thereby adjusting the resting power.

Additionally in some examples of the present disclosure, the optical aperture of the lens 100 can be adjusted. For example, the magnet 113 can be smaller disk magnets circumscribing an arbitrary large optical aperture. Further, in other examples, the magnet 113 can be a ring magnet with customized dimensions to increase the inner diameter and keep a small ratio between the inner and outer diameter to aid in minimizing extra radial volume. In these examples, the electromagnet 109 can be fabricated to match the necessary aperture.

Moving on to FIGS. 2A and 2B, shown are various depictions of the membrane layer 106. The membrane layer 106 can have a thickness of about 0.3 mm to 6 mm and a diameter of about 35 mm to 60 mm. The membrane layer 106 can be circular with an inner ridge 203 running along an inner perimeter of the membrane layer 106. The inner ridge 203 can create a channel that can be manipulated to direct optical fluid 123 flow within the lens 100. The inner ridge 203 can have a thickness of about 0.3 mm to 2 mm, an inner diameter of about 21 mm to 46 mm, and an outer diameter of about 23 mm to 55 mm. The center of the of the membrane layer 106 can create a central void 206. In various aspects, the central void can have a diameter of about 20 mm to 45 mm, or approximately 22 mm. Based at least in part on electromagnetic attenuation, the central void 206 can create a concave or convex shape.

In FIG. 2A, the membrane layer 106 is shown with a bulging center. In the example of FIG. 2A, the inner ridge 203 of the membrane layer 106 is compressed, causing a divot in the inner ridge 203. In some examples, the divot in the inner ridge 203 is cause from attraction forces between the electromagnet 109 and the magnet 113, this attractive force is represented by the down arrows in FIG. 2A. According to various examples, the pressure asserted on the inner ridge 203, can force optical fluid 123 from the inner ridge 203 and into a central void 206. The additional optical fluid in the central void 206 can cause the central void 206 of the membrane layer 106 to bulge as depicted in FIG. 2A. The pressure from the additional optical fluid 123 in the central void 206 and resultant membrane bulge is depicted with the up arrow in FIG. 2A.

In FIG. 2B, the membrane layer 206 is shown with a concave center. In the example of FIG. 2B, the inner ridge 203 of the membrane layer 106 is fully extended. This extension of the inner ridge 203 can be due to a repulsion of the electromagnet 109 and the magnet 113. The repulsion can create a pressure that inflates the inner ridge as depicted by the up arrows in FIG. 2B. As the inner ridge 203 is extended, fluid can flow from the central void 206 and into the inner ridge 203. In some examples, this can create a pressure pushing down on the central void 206 as depicted in FIG. 2B by the down arrow, causing the central void to assume a concave structure.

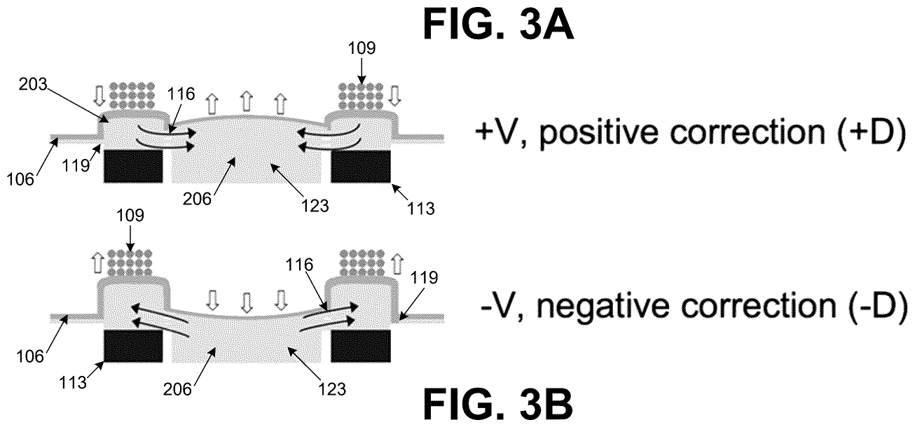

With reference to FIGS. 3A and 3B, shown is a cross-section schematic of an example of an assembled lens 100 according to various voltage polarities. In various examples, when voltage is applied to the electromagnet 109, the electromagnet 109 can move relative to the magnet 113, compressing or extending the inner ridge 203. In these examples, because the volume of the optical fluid 123 is fixed, the deformation of the inner ridge 203 shifts fluid between the inner ridge 203 and the center void 206. In other words, the displacement occurs via pressure gradients created by compression or extension of the inner ridge 203. In both FIGS. 3A and 3B, the black arrows indicate fluid flow pathways through openings in the center ridge support 116 and the center support of the second chamber and the white arrows depict deformation of the membrane layer 106. In various examples of the present disclosure, the size and number of holes in the center ridge support 116 and center support of the second chamber can control fluid flow resistance and thus focal power change speed.

FIG. 3A depicts an example of a positive voltage applied to the cross-section schematic of a lens 100. In this example, the application of the positive voltage draws the electromagnet 109 closer, compressing the inner ridge 203 and forcing optical fluid 123 into the central void 206. This can create a bulge of the center of the membrane layer 106 increasing the focal power in the positive direction.

FIG. 3B depicts an example of a negative voltage applied to the cross-section schematic of a lens 100. In this example, a negative voltage is applied, repelling the electromagnet 109. As the electromagnet 109 is repulsed, the inner ridge 203 can expand, drawing optical fluid 123 from the center void 206. This can create an inward budge of the membrane layer 106 reducing the focal power in the negative direction.

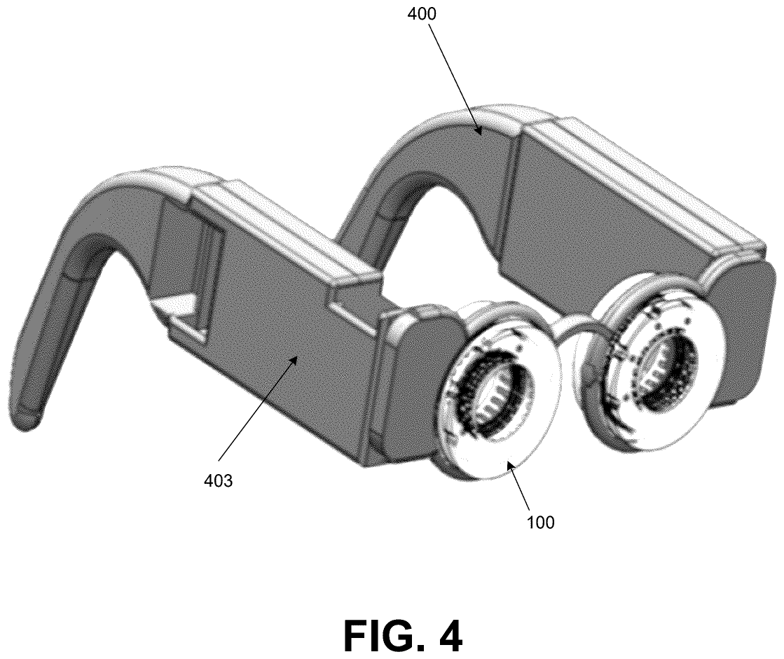

Referring next to FIG. 4, shown is one example of a pair of eyeglasses with a pair of lenses according to various embodiments of the present disclosure. According to some embodiments of the present disclosure, the eyeglasses depicted in FIG. 4 can represent a portable phoropter. The prototype of the electromagnetically actuated variable-focus ophthalmic liquid lens depicted in FIG. 4 has been successfully tested. As depicted in FIG. 4, the eyeglasses can include a pair of lens 100, a frame 400, and a voltage control mechanism 403.

The lens 100 used in the pair of lenses can employ the dynamic focal adjustment via electromagnetic actuation described above. In various examples, each lens 100 can operate independently, thus the focal power can be adjusted per lens 100. Since both lenses in the eyeglasses can operate independently, the customization of each lens 100 is high. In other words, independent prescriptions can be accommodated.

The frame 400 can house all of the materials of the eyeglasses. In various examples, the frame 400 can include a pair of lenses 100. The frame 400 depicted in FIG. 4 was developed as a prototype of the system for testing and analysis. In various examples of the present disclosure, the frame 400 can be design can be interchanged based at least in part on the aesthetic and comfort desires of the wearer. In other words, the frame 400 can be changed to include varying eyeglass frame shape, sizes, colors, etc. According to various embodiments of the present disclosure, the frame 400 can be shaped to house a voltage control mechanism 400.

A voltage control mechanism 403 can represent a control mechanism that can allow modulation of focal power based at least in part on the magnitude of the derived magnetic force from the electromagnet 109. In various examples, a higher voltage induces a stronger magnetic force in the electromagnet 109, resulting in a higher magnitude of focal power adjustment. Thus, the voltage polarity can determine whether the electromagnet 109 attracts or repels the magnet 113. The voltage control mechanism can be contained in the frame 400 of the eyeglasses according to various embodiments of the present disclosure. According to various embodiments of the present disclosure, the voltage control mechanism can include a battery, a motor, and potentiometer.

A battery can represent a power source for the manipulation of the lens 100. For example, the voltage of the battery can be modulated to adjust the corrective power of the lens 100. In various examples of the present disclosure, the battery can be an 9V battery or any other suitable battery with adequate voltage supply.

A motor can represent a motor driver capable of control the voltage applied to the electromagnet 109. In some embodiments, the motor can accept both analog and digital controls based at least in part on the initial optical settings of the lens 100. By accepting both analog and digital controls for voltage adjustment, the motor can allow for stepwise focal power change increments in approximately 0.25 D. In various examples, the analog control for the motor can include a switch that can alter the voltage polarity or turn off the voltage entirely. In other examples, digital controls can be used to optimize power usage by varying duty cycles of the voltage application.

A potentiometer can represent a variable resistor that can allow adjustable voltage. In other words, the potentiometer can control for the focal power. For example, the potentiometer can connect to the motor and the battery and can allow for control of the voltage output to the electromagnet 109 in the lens 100. For example, a stepper dial can act as a digital potentiometer that can allow for voltage changes that correlate to 0.25 D increments (e.g., benchmark diagnostic accuracy for focal power increments) to clearly delineate different focal power differences.

According to various embodiments, the lens can further implement a pupil tracking system to determine eye angle vergence which directly correlates to the visual distance an individual is attempting to focus, thereby inducing a proportional voltage to the system to adjust for that focal power. Currently, eye angle vergence and pupil tracking technology is available in many applications and can be incorporated in the system to be used with the lens 100.

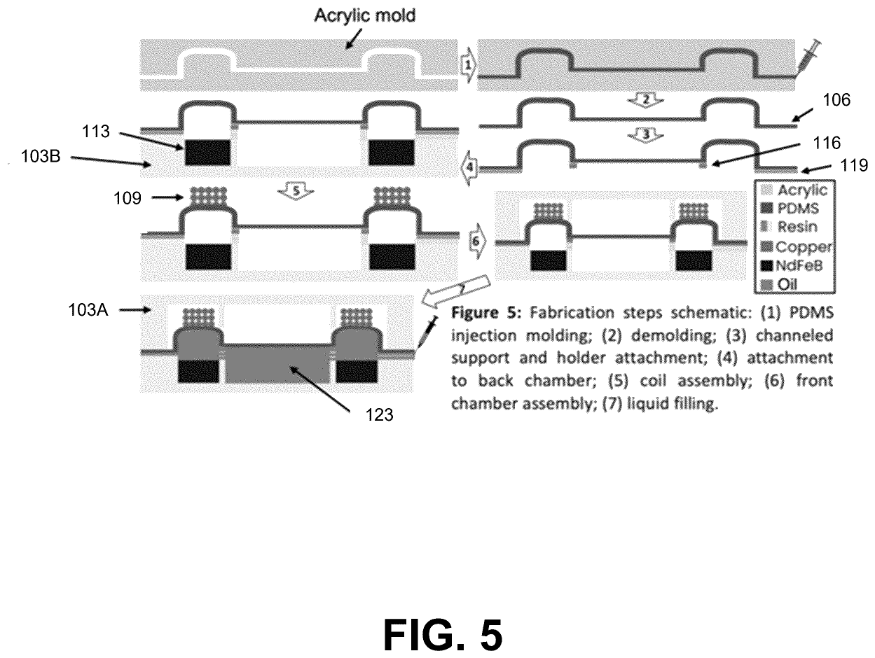

Referring next to FIG. 5, shown is an example of a fabrication process according to various embodiments of the present disclosure. As shown in the first diagram of FIG. 5, the process can begin with a mold. In various examples, the mold can be an acrylic mold, or a mold machined from metal, including aluminum, steel, copper, etc. In various examples, the center part of the mold (the flat area between the ridges) can be optically flat, with little to no surface variation and can be made with a material different than that used for the rest of the mold. In some examples, an acrylic disk with an optical finish can be used in the center of the mold while the rest can be made with a metal to prevent material distortion after repetitive heat cycles. Therefore, the mold can be used over many injection molding cycles to produce multiple PDMS membranes. Moving with the arrow labeled 1, the membrane layer 106 can be formed by injecting a liquid into the mold and allowing the membrane layer 106 to cure. Next, moving with the arrow labeled 2, the membrane layer 106 can be removed from the mold and moving with the arrow labeled 3, the center ridge support 116 and the membrane support 119 can be placed on the membrane layer 106. According to various embodiments, the center ridge support 116 can be placed on the inner edge of the inner ridge 203 of the membrane layer 106 and the membrane support 119 can be placed on the outer edge of the inner ridge 203, extending to the outer edge of the membrane layer 206. Moving with the arrow labeled 4, the second chamber 103B can be placed underneath the membrane layer 106 so that a magnet 113, the center ridge support 116, and the membrane support 119 are disposed between the membrane layer 106 and the second chamber 103B. Then, moving with the fifth arrow, the electromagnet 109 can be assembled and placed above the membrane layer 106. Once the electromagnet 109 is in place, the first chamber 103A can be placed on top of the electromagnet 109. The first chamber 103A can be linked with the second chamber 103B to fully enclose all elements within a central void 206 formed between the first chamber 103A and the second chamber 103B. Finally, moving with the arrow labeled 7, the optical fluid 123 can be injected into the void between the second chamber 103B and the membrane layer 106. The amount of optical fluid 123 injected determines the resting correction power of the lens 100.

It should be noted that while the lens 100 are generally described throughout the present disclosure through one directional frame of reference, the lens 100 can be flipped 180 degrees. Or in other words, the first chamber 103A can be either a front or back chamber and the second chamber 103B can be either a front or back chamber. The position of the elements within the chambers 103 can remain the same but the voltage requirements will also flip.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

1. A lens, comprising:
a first chamber;
a second chamber connected to the first chamber to form a central void;
a membrane layer disposed between the first chamber and the second chamber in the central void, the membrane layer being flexible with an inner ridge;
an electromagnet disposed between the first chamber and the membrane layer, the electromagnet adjacent to the inner ridge of the membrane layer; and
a magnet disposed between the second chamber and the membrane layer, the magnet adjacent to the inner ridge of the membrane layer.

2. The lens of claim 1, further comprising a center ridge support disposed between the second chamber and the membrane layer, wherein the center ridge support supports an inner edge of the inner ridge of the membrane layer.

3. The lens of claim 1, further comprising a membrane support disposed between the second chamber and the membrane layer, wherein the membrane support supports an outer edge of the inner ridge of the membrane layer.

4. The lens of claim 1, further comprising an optical fluid dispersed between the second chamber and the membrane layer, the optical fluid having a high-refractive index.

5. The lens of claim 4, wherein the optical fluid is a silicone oil.

6. The lens of claim 1, wherein the membrane layer is made of at least one of the following materials: a polymethylmethacrylate (PMMA), a polydimethylsiloxane (PDMS), an off-stoichiometry thiol-ene polymer, a silicone elastomer, a polyurethane elastomer, a liquid silicone rubber, a fluorinated ethylene propylene, a styrene methyl methacrylate, or a polyethylene terephthalate glycol.

7. The lens of claim 4, wherein the center ridge support and the center support of the second chamber each include a plurality of openings, wherein the optical fluid can flow through the plurality of openings at a controlled focus speed.

8. A method, comprising:
adjusting a focal power of a lens, wherein the lens comprises:
a first chamber;
a second chamber connected to the first chamber to form a central void;
a membrane layer disposed between the first chamber and the second chamber in the central void, the membrane layer being flexible with an inner ridge;
an electromagnet disposed between the first chamber and the membrane layer, the electromagnet adjacent to the inner ridge of the membrane layer; and
a magnet disposed between the second chamber and the membrane layer, the magnet adjacent to the inner ridge of the membrane layer; and
wherein the focal power of the lens is adjusted by applying electromagnetic actuation to adjust a curvature of the membrane layer of the lens.

9. The method of claim 8, wherein the lens further comprises:
a center ridge support disposed between the second chamber and the membrane layer, the center ridge support supporting an inner edge of the inner ridge of the membrane layer;
a membrane support disposed between the second chamber and the membrane layer, the membrane support supporting an outer edge of the inner ridge of the membrane layer; and
an optical fluid dispersed between the second chamber and the membrane layer, the optical fluid having a high-refractive index.

10. The method of claim 9, wherein adjusting the focal power of the lens further comprises:
applying a positive voltage to the electromagnet;
compressing the inner ridge of the membrane layer as the magnet is attracted by the positive voltage of the electromagnet; and
flowing the optical fluid from the inner ridge of the membrane layer and into a central void, the optical fluid increasing in volume in the central void and a resulting pressure pushing against the membrane layer creating a converging lens.

11. The method of claim 9, wherein adjusting the focal power of the lens further comprises:
applying a negative voltage to the electromagnet;
extending the inner ridge of the membrane layer as the magnet is repelled by the negative voltage of the electromagnet; and
flowing the optical fluid from a central void and into the extended inner ridge, the optical fluid decreasing in volume in the central void and a resulting pressure pulling against the membrane layer creating a diverging lens.

12. The method of claim 8, wherein the membrane layer is made of at least one of the following materials: a polymethylmethacrylate (PMMA), a polydimethylsiloxane (PDMS), an off-stoichiometry thiol-ene polymer, a silicone elastomer, a polyurethane elastomer, a liquid silicone rubber, a fluorinated ethylene propylene, a styrene methyl methacrylate, or a polyethylene terephthalate glycol.

13. The method of claim 9, wherein the center ridge support and a center support of the second chamber each has a plurality of openings, wherein the optical fluid can flow through the plurality of openings at a controlled focus speed.

14. A system, comprising:
an eyeglass frame; and
two lenses, wherein each lens comprises:
a first chamber;
a second chamber connected to the first chamber to form a central void;
a membrane layer disposed between the first chamber and the second chamber in the central void, the membrane layer being flexible with an inner ridge;
an electromagnet disposed between the first chamber and the membrane layer, the electromagnet adjacent to the inner ridge of the membrane layer; and
a magnet disposed between the second chamber and the membrane layer, the magnet adjacent to the inner ridge of the membrane layer.

15. The system of claim 14, further comprising a voltage control mechanism, the voltage control mechanism comprising:
a battery disposed within the eyeglass frame; and
a motor, wherein the motor is powered by the battery and wherein the motor controls voltage modulation of each lens.

16. The system of claim 14, wherein each lens further comprises:
a center ridge support disposed between the second chamber and the membrane layer, the center ridge support supporting an inner edge of the inner ridge of the membrane layer;
a membrane support disposed between the second chamber and the membrane layer, the membrane support supporting an outer edge of the inner ridge of the membrane layer; and
an optical fluid dispersed between the second chamber and the membrane layer, the optical fluid having a high-refractive index.

17. The system of claim 16, wherein the optical fluid is a silicone oil.

18. The system of claim 14, the membrane layer is made of at least one of the following materials: a polymethylmethacrylate (PMMA), a polydimethylsiloxane (PDMS), an off-stoichiometry thiol-ene polymer, a silicone elastomer, a polyurethane elastomer, a liquid silicone rubber, a fluorinated ethylene propylene, a styrene methyl methacrylate, or a polyethylene terephthalate glycol.

19. The system of claim 16, wherein the center ridge support and a center support of the second chamber each include a plurality of openings wherein the optical fluid can flow through the plurality of openings at a controlled focus speed.

20. The system of claim 14, wherein a correction for a first lens is different from a correction for a second lens.
